(19) United States
(12) Patent Application Publication
(10) Pub. No.: US 2026/0210501 A1
(43) Pub. Date: Jul. 23, 2026

(54) NOZZLE PROTECTING BLOW-OFF CAP INSERT

(71) Applicant: Tyco Fire Products LP, Cranston, RI (US)

(72) Inventors: David Strobel, Marinette, WI (US); Jonathan Ehlers, Marinette, WI (US)

(73) Assignee: Tyco Fire Products LP, Cranston, RI (US)

(21) Appl. No.: 19/033,292

(22) Filed: Jan. 21, 2025

(51) Int. Cl. F17C 13/06; A62C 3/07; A62C 13/76; A62C 31/02

(52) U.S. Cl. CPC F17C 13/06; A62C 3/07; A62C 13/76; A62C 31/02

(57) ABSTRACT

Assembly and apparatus related to a fire suppression system are described herein. The nozzle cap and insert assembly includes a discharge nozzle, a cap insert, and a nozzle cap. The discharge nozzle includes an aperture on an elongated body such as a cylinder. The cap insert includes a plate and, in some implementations, a sidewall and a perforation. The nozzle cap incudes a cavity with a depth equal to a thickness of the plate of the cap insert and a length of the discharge nozzle. The diameter of the cap insert is structured to substantially or completely cover the top of the discharge nozzle and the thickness of the plate is structured to fit inside the cavity of the nozzle cap. The cap insert is made of a heat-resistive rigid material, similar or the same as the metal of the discharge nozzle.

### BACKGROUND

Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppressant (e.g., an agent) throughout the area. When the fire suppressant discharges from a nozzle, a nozzle cap is forcefully removed or blown off the nozzle.

### SUMMARY

At least one aspect relates to a nozzle cap and insert assembly including a discharge nozzle, a cap insert, and a nozzle cap. The discharge nozzle includes an aperture. The insert includes a plate structured to substantially or completely cover a top of the discharge nozzle. The nozzle cap includes a cavity depth equal to a thickness of the plate and a length of the discharge nozzle. In some aspects, the discharge nozzle is cylindrical. In some aspects, the aperture is located on the top of the discharge nozzle, and the plate of the insert is structured to substantially or completely cover the aperture. In some aspects, the plate of the insert further includes a perforation located such that the perforation does not overlap with the aperture when the plate is centered to the top of the discharge nozzle.

At least one aspect relates to a discharge nozzle with the aperture is located on the longitudinal face of the discharge nozzle. The insert further includes a side wall perpendicularly connected to an edge of the plate and structured to substantially or completely cover the first aperture.

At least one aspect relates to a discharge nozzle further includes a second aperture. In some aspects, the nozzle cap is made of a polymer material and the insert is made of a material that maintains rigidity at high temperatures (e.g., metal).

At least one aspect relates to a nozzle cap and insert assembly including a cylindrical discharge nozzle including an aperture on a top of the cylindrical discharge nozzle, an insert including a plate structured to substantially or completely cover the top and first aperture of the cylindrical discharge nozzle, and a nozzle cap with a cavity depth equal to a thickness of the plate and a length of the discharge nozzle. In some aspects, the plate of the insert further includes a perforation located such that the perforation does not overlap with the first aperture when the plate is centered with the top of the discharge nozzle. In some aspects, the discharge nozzle further includes a second aperture. In some aspects, the insert further includes a side wall perpendicularly connected to an edge of the plate.

At least one aspect relates to the nozzle cap made of a polymer material and the insert made of a material that maintains rigidity at high temperatures (e.g., metal).

At least one aspect relates to the discharge nozzle including a circumferential groove on the longitudinal face and the nozzle cap includes a protrusion along an edge of the cavity. The protrusion is structured to couple with the circumferential groove.

At least one aspect relates to a nozzle attachment including a first end with a hole to wrap around a circumference of the cylindrical body of the discharge nozzle and a second end protruding from an external portion of the nozzle cap.

At least one aspect relates to an insert including a circular plate with a thickness, made of a heat-resistive metal; and a perforation spanning the thickness. In some aspects, a side wall perpendicularly connects to an edge of the circular plate. In some aspects, a diameter of the circular plate is the same or substantially similar to a diameter of a discharge nozzle with an aperture. In some aspects, the perforation is located such that the perforation does not overlap with the aperture when the circular plate is centered to a top of the discharge nozzle. In some aspects, the discharge nozzle is made of the heat-resistive metal.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1. is a side view of a mobile equipment including a fire suppression system.

FIG. 2 is a perspective view of an example of a fire suppression system.

FIG. 3 is an exploded view of a nozzle cap and insert assembly with a discharge nozzle of FIG. 2.

FIG. 4 is a top view of a nozzle cap and insert assembly of FIG. 3.

FIG. 5 is a cross-sectional side view of a nozzle cap and insert assembly of FIG. 3.

FIG. 6 is a cross-sectional side view of a nozzle cap and insert assembly of FIG. 3.

FIG. 7 is a perspective view of a cap insert of FIG. 3.

FIG. 8 is a top view of a cap insert of FIG. 3.

FIG. 9 is a side view of a cap insert of FIG. 3.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### DETAILED DESCRIPTION

Before turning to the figures, which illustrate various implementations in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a fire suppression system is shown, according to various implementations. The fire suppression system includes one or more tanks. In some examples the tanks are arranged as master tank and subordinate tank subassemblies. Each tank is coupled with a valve and an actuator to open the tanks and release the fire suppressant stored inside. Each tank, or each tank subassembly, is fluidly coupled with a manifold assembly that includes selector valves. The tanks may be opened by an actuator and/or a valve responsive to receiving a signal that a fire is present in or near an area. Opening the tanks causes a pressure differential between the manifold and the tanks, which drives the fire suppressant to flow through the manifold. The flow of fire suppressant generates a pressure threshold inside the manifold. Such pressure actuates the selector valves to an open position, thereby allowing the fire suppressant to flow through the selector valves to a distribution system or nozzle. Advantageously, the fire suppression system utilizes the pressure generated inside to the manifold to distribute fire suppressant without additional external pressure sources (e.g., nitrogen pilot tanks, etc.). Therefore, utilizing the pressure generated inside the manifold reduces the overall complexity and/or cost of the fire suppression system by removing external pressure tanks and their associated connective line.

The fire suppression system may be implemented in mobile equipment, work machines, or other mobile equipment. Mobile equipment may include systems or system equipment that may ignite or cause surrounding equipment to ignite. Operation of such mobile equipment may generate or dispel fluids, oils, or other byproducts that may obstruct the discharge nozzles of the fire suppression system. Nozzle caps may be implemented to protect the discharge nozzles from obstructing byproducts. When damaged by high temperatures or fire, the nozzle caps obstruct or prevent proper distribution of fire suppressant from the discharge nozzle. A cap insert may be positioned inside the nozzle cap to ensure that the nozzle cap is displaced from the discharge nozzle when discharging fire suppressant.

### Mobile Equipment

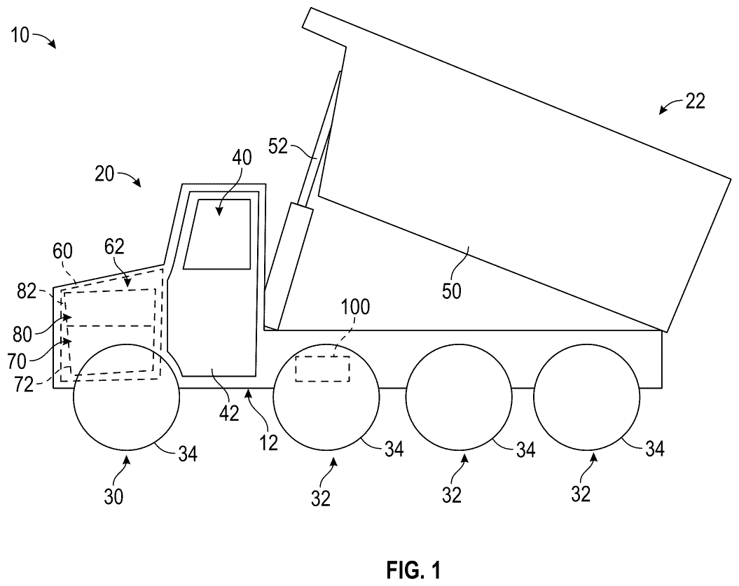

Referring to FIG. 1, a mobile equipment 10 is shown according to an exemplary implement. The mobile equipment 10 may be a type of mobile equipment, such as a commercial mobile equipment, a farm mobile equipment, an industrial mobile equipment, or a consumer mobile equipment. Such mobile equipment can include, but are not limited to, draglines, slag pot carriers, slab carriers, tunnel boring machines, waste management equipment, forestry mobile equipment, hydraulic excavators, haul trucks, wheeled loaders, dozers, scoop trams, shuttle cars, public transportation mobile equipment, over-the-road trucks, cargo transport mobile equipment, graders, dump trucks, and consumer passenger mobile equipment.

In the implement shown in FIG. 1, the mobile equipment 10 is a dump truck. The mobile equipment 10 includes a chassis, shown as frame 12, extending longitudinally along the mobile equipment 10. The frame 12 supports a first portion of the mobile equipment 10, shown as body 20. In some implementations, the frame 12 additionally supports a second portion of the mobile equipment 10, shown as equipment 22. In other implementations, the equipment 22 is omitted. As shown in FIG. 1, the body 20 is positioned near the front of the frame 12 with respect to the direction of travel of the mobile equipment 10, and the equipment 22 is positioned rearward of the body 20. In other implementations, the body 20 extends rearward of the equipment 22.

The mobile equipment 10 further includes a series of tractive assemblies, shown as front tractive assembly 30 and rear tractive assemblies 32. As shown, the mobile equipment 10 includes one front tractive assembly 30 and three rear tractive assemblies 32. In other implementations, the mobile equipment 10 includes more or fewer front tractive assemblies 30 and/or rear tractive assemblies 32. The front tractive assembly 30 and the rear tractive assemblies 32 each include two or more tractive elements (e.g., wheels, tracks, etc.), shown as wheel and tire assemblies 34. The wheel and tire assemblies 34 are rotatably coupled to the frame 12 and engage the ground. The wheel and tire assemblies 34 support the frame 12, the body 20, and the equipment 22. The front tractive assembly 30 and the rear tractive assemblies 32 can include differentials, drive shafts, bearings, wheel hubs, brakes, and other components.

The body 20 includes a cabin, shown as front cabin 40. The front cabin 40 is configured to house one or more operators throughout operation of the mobile equipment 10. The front cabin 40 can include components that facilitate operation of the mobile equipment 10, such as seats, controls for driving the mobile equipment 10 (e.g., displays, gauges, a steering wheel, pedals, shift levers, etc.), and/or controls for operating the equipment 22 (e.g., touchscreens, switches, knobs, buttons, joysticks, etc.). The body 20 can include one or more doors 42 that open and close to selectively facilitate or prevent access to the front cabin 40. Alternatively, the mobile equipment 10 may be an autonomous or semiautonomous mobile equipment. Accordingly, certain processes, such as steering, braking, and accelerating the mobile equipment 10 and controlling the equipment 22 may be controlled by a controller onboard or offboard the mobile equipment. The controller may perform such operations without, or with reduced input from, an operator. In such implementations, certain components may be removed from the front cabin 40 or the front cabin 40 may be omitted entirely.

The components included in the equipment 22 vary based upon the intended use of the mobile equipment 10. In the implement shown in FIG. 1, the mobile equipment 10 is a dump truck configured to haul and deposit material (e.g., dirt, gravel, sand, coal, etc.). The equipment 22 includes a container, shown as bed 50, that is configured to contain a volume of material. The bed 50 can have an opening along a top side to facilitate depositing material into the bed 50 and an opening along a rear side to facilitate dumping material. The bed 50 is pivotally coupled to the frame 12. The equipment 22 further includes a linear actuator, shown as hydraulic cylinder 52, that is coupled to the frame 12 and the bed 50. The hydraulic cylinder 52 is configured to extend and retract to rotate the bed 50 relative to the frame 12 between a raised position and a lowered position. In the lowered position, the bed 50 is configured to store material for transport. In the raised position, shown in FIG. 1, the bed 50 is configured to dump the material out through the opening along the rear side of the bed 50.

The body 20 further defines an enclosure, shown as engine compartment 60, defining a volume 62 that is at least partially enclosed by the engine compartment 60. As shown, the engine compartment 60 is positioned forward of the front cabin 40 and the equipment 22. In other implementations, the engine compartment 60 is positioned rearward of the front cabin 40 and/or the equipment 22. The engine compartment 60 can include one or more structural members (e.g., frame rails, support members, brackets, etc.), coverings (e.g., sheet metal that extends between structural members, firewalls, body panels, grills, etc.), movable members (e.g., doors, hoods, etc.), or other components coupled to the frame 12, all of which cooperate to define the volume 62. The volume 62 can be accessible, selectively accessible, or inaccessible by an operator positioned outside of the mobile equipment 10. By way of example, a door may be movable to selectively permit access to the volume 62. In other implementations, enclosed or partially enclosed volumes are defined by an enclosure of the mobile equipment 10 other than the engine compartment 60. By way of example, such enclosures can include lubrication rooms, storage areas, and the front cabin 40.

According to an exemplary implement, the mobile equipment 10 includes a first drive system, shown as powertrain 70. The powertrain 70 may include a primary driver, shown as engine 72. The engine 72 receives fuel (e.g., diesel, gasoline, etc.) from a fuel tank and combusts the fuel to generate mechanical energy. In other implementations, the primary driver is an electric motor that consumes electrical energy (e.g., stored in a battery, from a generator, etc.) to generate mechanical energy. The powertrain 70 further includes a transmission that receives the mechanical energy and provides a rotational mechanical energy output (e.g., at a different speed, torque, and/or direction of rotation than that of the engine 72). The transmission can be rotationally coupled to a transfer case assembly and one or more drive shafts. The one or more drive shafts can be coupled to one or more differentials configured to transfer the rotational mechanical energy from the one or more drive shafts to the front tractive assembly 30 and/or the rear tractive assemblies 32. The front tractive assembly 30 and/or the rear tractive assemblies 32 then propel the mobile equipment 10. According to an exemplary implement, the engine 72 is an internal combustion engine that utilizes compression-ignition of diesel fuel. In alternative implementations, the engine 72 is another type of device (e.g., a fuel cell, an electric motor, a spark-ignition engine, etc.) that utilizes a different power source (e.g., compressed natural gas, gasoline, hydrogen, electricity, etc.). The powertrain 70 of the mobile equipment 10 can be a hybrid powertrain or a non-hybrid powertrain (e.g., a fully electric powertrain, a powertrain powered exclusively by an internal combustion engine, etc.).

In some implementations, the mobile equipment 10 includes a second drive system, shown as equipment drive system 80. The equipment drive system 80 is configured to power actuation of the equipment 22. The equipment drive system 80 includes a driver, shown as pump 82. The pump 82 is a hydraulic pump configured to supply pressurized hydraulic fluid to and/or remove pressurized hydraulic fluid from the hydraulic cylinder 52 to raise and lower the bed 50. The pump 82 can be directly powered by the engine 72, can be powered by another energy source (e.g., a second engine, an electric motor powered by energy stored in a battery, etc.). In other implementations, the equipment drive system 80 is configured to provide a different type of energy to power actuation of the equipment 22 (e.g., pressurized gas, electrical energy, a rotating shaft, etc.). Accordingly, in such implementations, the driver of the equipment drive system 80 may instead be a compressor, a generator, an electric motor, or another type of driver. Alternatively, the pump 82 can be omitted, and the equipment drive system 80 may be driven directly by the engine 72 (e.g., a through a drive shaft).

The powertrain 70 and/or the equipment drive system 80 extend at least partially within the volume 62 defined by the engine compartment 60. As shown in FIG. 1, the engine 72 and the pump 82 are positioned within the engine compartment 60. Other components of the powertrain 70 (e.g., the transmission, driveshafts, etc.) extend outside of the engine compartment 60. Other components of the equipment drive system 80 (e.g., hydraulic lines, valves, etc.) extend outside of the engine compartment 60. In other implementations, the equipment drive system 80 is positioned completely within or completely outside of the engine compartment 60.

Throughout operation, one or more components or surfaces of the powertrain 70 and/or the equipment drive system 80 have the potential to supply flammable material or act as an ignition source, such that a flame is emitted therefrom. Such flames can occur as a result of malfunctioning components, buildup of outside sources of flammable material, or through other circumstances. By way of example, a fuel line or a hydraulic fluid line can rupture, spraying fuel or hydraulic fluid that acts as a flammable material to fuel a fire. By way of another example, flammable material from outside of the mobile equipment 10 (e.g., sawdust, grass clippings, coal dust, etc.) can build up and fuel a fire. Throughout operation, many components of the powertrain 70 and the equipment drive system 80 regularly reach elevated temperatures. When flammable materials come into contact with such heated components and surfaces, the flammable materials can ignite, causing flames to be emitted. Any component or surface that has a potential to act as fuel, flammable material, or an ignition source and thereby ignite, produce, sustain, or otherwise cause an undesired flame to be emitted therefrom is referred to herein as a “hazard.”

Components of the mobile equipment 10, including components of the powertrain 70 and the equipment drive system 80 can act as hazards. Such components can have the potential to supply flammable materials, such as oil or fuel. Components within the mobile equipment 10 can reach elevated temperatures due to the combustion of fuel (e.g., contact with the combusting fuel, contact with exhaust gasses, etc.), due to electrical resistance, due to resistance within a hydraulic or pneumatic circuit, due to friction, or through other sources. Potential hazards within the mobile equipment 10 include, but are not limited to, heated surfaces of a block of the engine 72, motors, turbochargers, superchargers, filters, exhaust components, radiators, pumps, compressors, valves, wires, fluid lines, and filters. Ignited hazards maybe treated by a fire suppression system 100 that is integrated into the mobile equipment 10.

### Fire Suppression System

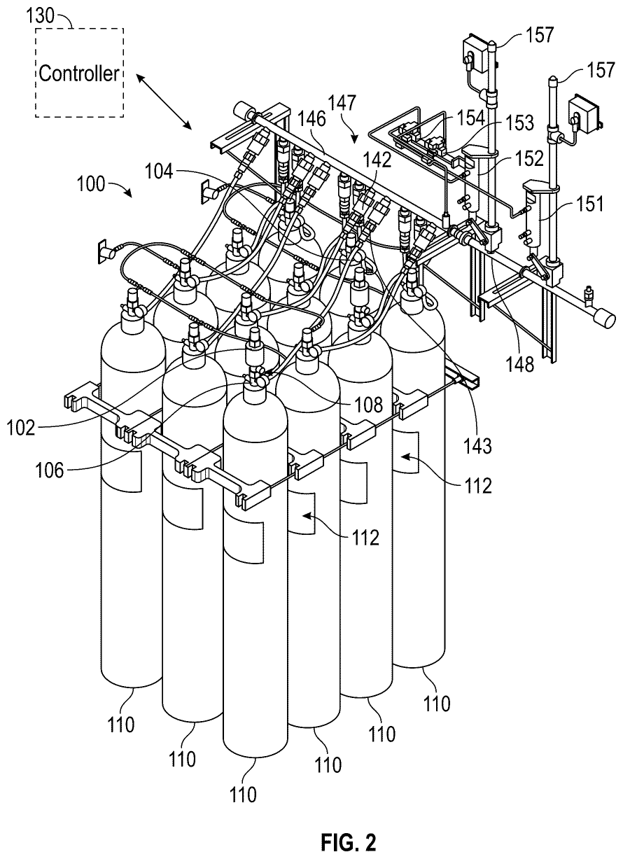

Referring to FIG. 2, a perspective view of a fire suppression system 100 is shown. The fire suppression system 100 can supply fire suppressant to one or more potentially flammable objects or areas to be protected. The fire suppression system 100 includes a supply of fire suppressant (e.g., a suppressant supply assembly), shown as tank subassemblies 112, which provide the fire suppressant for distribution by the fire suppression system 100 to address fires or hazard conditions in the areas. The fire suppression system 100 supplies the fire suppressant onto and/or around the areas, controlling or suppressing fires associated with (e.g., on, affecting, nearby, etc.) the areas. The fire suppression system 100 includes a controller 130 configured to selectively operate one or more control valves (e.g., electrically-actuated valves, pneumatically-actuated valves, etc.), shown solenoids 153 and 154. The solenoids 153 and 154 serve to open or assist in opening the selector valves 151 and 152 based on an activation signal. A manifold 147 couples the selector valves 151 and 152 to the tanks 110. The manifold 147 supplies the fire suppressant to a distribution network downstream from selector valves 151 and 152 at a pressure threshold, where the fire suppressant is then distributed to address fires and/or hazard conditions in the areas. The fire suppression system 100 can be used alone or in combination with other types of fire suppression systems (e.g., a sprinkler system, a portable fire extinguisher, etc.). In some implementations, multiple fire suppression systems 100 are used in combination with one another to cover a larger area or hazard.

The fire suppressant supply includes a series of containers (e.g., vessels, suppressant containers, vats, drums, tanks, canisters, cartridges, or cans, etc.), shown as tanks 110, that each contain a volume of fire suppressant. The tanks 110 are arranged in groups or subassemblies (e.g., container subassemblies), shown as tank subassemblies 112. Each tank 110 is coupled to a valve 106, puncture device, or activator assembly, shown as actuator 102. The actuators 102 can selectively fluidly couple an internal volume of each tank 110 to a conduit (e.g., a hose, a pipe, a tube, etc.), shown as supply conduit 104. In some implementations, the actuators 102 are manually actuated by a user (e.g., by hand). In other implementations, the actuators 102 are actuated by a signal (e.g., an electrical signal, a flow of pressurized fluid, etc.). In other implementations, the actuators 102 are omitted, and the tanks 110 are directly coupled to the supply conduit 104.

The supply conduit 104 fluidly couples the tanks 110 to regulator valves 142. In some examples, the supply conduit 104 fluidly couples the tanks 110 to one another, such that the tank subassembly 112 has a single, continuous volume. The supply conduit 104 may be an assembly including one or more straight or bent sections of conduit and/or one or more fittings. Each tank 110 may be a non-refillable tank designed for one-time use, such that the tanks 110 are not refilled or reused. In some implementations, each tank 110 is refillable and capable of repeated use. Each tank 110 may be manufactured from a metal material (e.g., steel, aluminum, etc.). In some implementations, the tanks 110 are manufactured from different materials and/or combinations of materials (e.g., a composite, such as fiberglass or carbon fiber).

A sensor (e.g., pressure sensor, strain-gauge, piezometer, manometer, a quantity sensor, a fill level sensor, etc.), shown as sensor 108, is coupled to the tanks 110 and can detect the pressure and/or the quantity of the fire suppressant within the tank subassembly 112. The sensor 108 may be used to monitor the performance of the fire suppression system 100 and indicate if maintenance is required. By way of example, the sensor 108 may measure a pressure of the tank subassembly 112 and send an indication to the controller 130 that maintenance is required (e.g., to address a leak in the supply conduit, etc.) if the measured pressure is higher or lower than a pressure threshold. Each tank subassembly 112 may be coupled to a different sensor 108. The sensor 108 is operatively coupled to the controller 130.

Referring further to FIG. 2, each tank subassembly 112 includes one or more tanks 110 fluidly coupled to a supply conduit 104. The tanks 110 included in the tank subassembly 112 may be connected in parallel such that the tanks 110 each supply fire suppressant at approximately the same rate. The tanks 110 included in the tank subassembly 112 may be fluidly coupled in series such that the fire suppressant contained in one of the tanks 110 is depleted before the fire suppressant contained in the next tank 110 in the series is supplied. By way of example, each tank 110 in the tank subassemblies 112 are coupled with valve 106 that may be actuated open from a closed position (i.e., not supplying fire suppressant). In this example, an actuator 102 is coupled with one or more of the valves 106 and is in communication with the controller 130. The first actuator 102 would open the first valve 106, and the succeeding actuator 102 in the series would then open the succeeding valve 106 once the fire suppressant contained in the preceding tank 110 is depleted. In this way, one or more sensors 108 (e.g., pressure sensors, fill level sensors, etc.) may be communicatively coupled with the controller 130, such that the controller 130 may send an electronic signal to the succeeding actuator 102 responsive to receiving data from the sensors 108 indicative of the preceding tank 110 being depleted. As shown in FIG. 2, the tank subassemblies can be arranged in with one or more master tanks 110 and one or more subordinate tanks 110 in a tank subassembly 112. In this example, the master tanks 110 are coupled with a valve (e.g., the valve 106) and an electronic actuator (e.g., actuator 102) and the subordinate tanks 110 are coupled with a valve and a pressure activated actuator (e.g., actuator 102). The master tanks are coupled with the subordinate tanks by an actuation line that transmits pressure from the master tank to the subordinate tanks. The master tanks are opened by the electronic actuators responsive to receiving a signal from the controller 130 that a fire is present. The increased pressure from the master container causes the pressure activated actuators on the subordinate tanks to open the subordinate tanks.

As shown in FIG. 2, the manifold 147 and the tanks 110 can be joined by a series of regulator valves 142. Each regulator valve 142 can receive fire suppressant from one of the tanks 110 at a first pressure and can deliver the fire suppressant to the manifold 147 at a second pressure. In some examples, the second pressure is lower than the first pressure. Each supply conduit 104 includes an end portion that is fluidly coupled to one of the regulator valves 142. As shown in FIG. 2, each tank 110 is connected to a regulator valve by a supply conduit 104. The tanks 110 can be linked in series by the supply conduit 104. In this example, multiple tanks 110 are fluidly coupled with one regulator valve 142.

Each regulator valve 142 can be a pressure reducing regulator that maintains the pressure downstream of the regulator valve 142 (e.g., the second pressure in the manifold 147) at a desired threshold pressure. Responsive to the downstream pressure (e.g., the pressure in the manifold 147) falling below the desired pressure, the regulator valve 142 can permit a larger volume of fire suppressant to flow from the tanks 110 through the regulator valve 142. Responsive to the manifold 147 reaching the desired threshold pressure, the regulator valve 142 limits or prevents further fire suppressant from passing through the regulator valve 142 to maintain the threshold pressure. While the internal pressure of the manifold 147 remains at or above the desired threshold pressure, the regulator valve 142 may prevent additional fire suppressant from flowing through the regulator valve 142. The desired threshold pressure may be predetermined (e.g., preset by an operator when initially installing the fire suppression system 100). In an example, the threshold pressure is at least 60 bar. By way of example, the once the manifold 147 reaches the pressure threshold from the flow of fire suppressant through the manifold 147, the selector valves 151 and 152 are actuated open by the internal pressure of the manifold 147. In some examples, the solenoids 153 and 154 assist in opening the selector valves 151 and 152 in addition to the threshold pressure inside the manifold 147. In this way, the fire suppression system 100 can utilize the pressure internal to the manifold 147 to distribute fire suppressant without additional external pressure sources (e.g., nitrogen pilot tanks, etc.). Therefore, utilizing the threshold pressure inside the manifold 147, reduces the overall cost of the fire suppression system 100 by removing external pressure tanks and their associated connective line.

Each tank 110 can be coupled with a flow control element, shown as check valve 143, positioned between the tanks 110 and the corresponding regulator valve 142. The check valve 143 fluidly couples the tanks 110 to the corresponding regulator valve 142. The check valve 143 permits flow from the tanks 110 to the regulator valve 142 and limits (e.g., prevents) flow from the regulator valve 142 back to the tanks 110.

Still referring to FIG. 2, the manifold 147, fluidly couples the downstream sides of the regulator valve 142 to one another and to one or more valves (e.g., selector valves, ball valves, slide valves, pressure regulating valves, etc.), shown as a first selector valve 151 and a second selector valve 152. In other implementations, the manifold 147 is connected to more or fewer regulator valves 142 and/or selector valves.

In some implementations, one or more of the tank subassemblies 112 may be at different pressures before and/or after supplying the fire suppressant to the regulator valve 142. By way of example, the fire suppressant within the tanks 110 of the first tank subassembly 112 may be pressurized to 300 bar, and the fire suppressant within the tanks 110 of the second tank subassembly 112 may be pressurized to 300 bar before and/or after supplying the fire suppressant to the regulator valve 142. Regardless of this discrepancy in the first pressure on the upstream sides of the regulator valves 142, the regulator valves 142 may regulate the second pressure downstream of the regulator valves 142 to be equal, such that the pressure within the support manifold 146 may be substantially homogenous.

As shown, the manifold 147 includes a first section or portion or inlet manifold portion, shown as support manifold 146, fluidly coupled to a second section or portion or outlet manifold portion, shown as selector valve manifold 148. The support manifold 146 can be directly fluidly coupled to each of the regulator valves 142. The support manifold 146 unites the flow of gas or fluid downstream of each of the regulator valve 142. The support manifold 146, the regulator valves 142, check valves 143, and supply conduits 104 can form a pressure regulation assembly that maintains a pressure threshold within the manifold 147. The selector valve manifold 148 can be directly fluidly coupled to the selector valves 151 and 152 and the discharge nozzles 157. The selector valve manifold 148 distributes the united flow of gas or fluid to each of the selector valves 151 and 152. Accordingly, the support manifold 146 and the selector valve manifold 148 fluidly couple the regulator valves 142 to the first and second selector valves 151 and 152. The manifold 147 may define a single, continuous manifold volume that extends uninterrupted throughout the support manifold 146 and the selector valve manifold 148 from the regulator valve 142 to the selector valves 151 and 152. In some implementations, the manifold 147 is a single, continuous piece (e.g., a weldment of several pipes). In other implementations, the manifold 147 is formed from several pieces coupled to one another (e.g., hoses or pipes coupled by one or more fittings, etc.).

In some examples, each of the selector valves 151 and 152 are connected to a larger piping distribution network than what is shown in FIG. 2. The piping distribution network supplies fire suppressant to nozzles (e.g., open nozzles, sprinklers, etc.) shown as discharge nozzles 157. The fire suppressant is distributed through the discharge nozzles 157 to an area to suppress detected fires. The piping distribution network may be assemblies including one or more straight or bent sections of conduit and/or one or more fittings. The piping distribution network can deliver the fire suppressant to the areas through one or more of the discharge nozzles 157. More discharge nozzles 157 may be needed to control or suppress a fire if the area is large, the intensity of the fire is great, or for other reasons. The fire suppression system 100 may supply fire suppressant through all the discharge nozzles 157 simultaneously. Alternatively, the fire suppression system 100 may supply fire suppressant through only a certain subset of the discharge nozzles 157. In some implementations, a fire associated with or in an area is suppressed by the fire suppressant distributed by one or more discharge nozzles 157. In an implementation, the discharge nozzles are covered by caps, covers, lids, or other mechanical structures that prevent other objects (e.g., dirt, dust, etc.) from occluding the discharge nozzles. In an implementation, each cap or other mechanical structure to be removed by the pressure of the fire suppressant discharging from a discharge nozzle 157. In an implementation, the cap may be replaced back on the discharge nozzle 157 to protect the discharge nozzle 157 until another discharge of the fire suppressant.

### Nozzle Cap and Insert Assembly

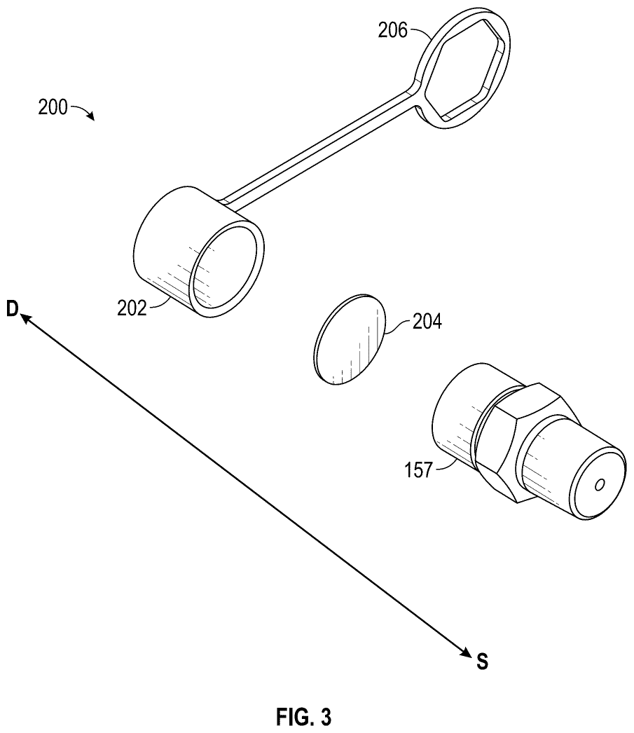

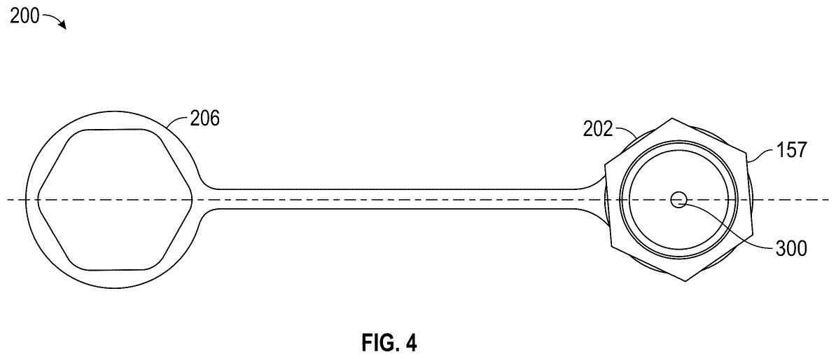

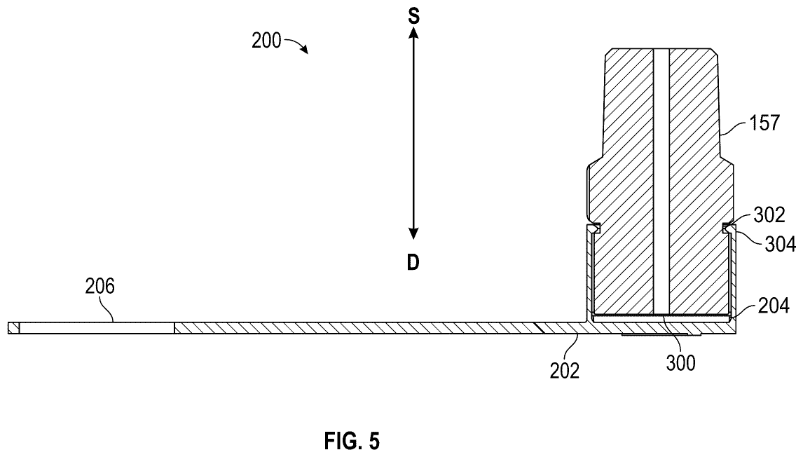

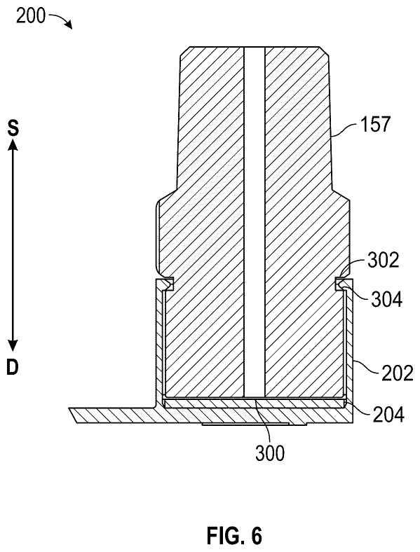

Referring to FIGS. 3-6, a nozzle cap and insert assembly 200 with a discharge nozzle 157 of FIG. 3 is shown. In FIG. 3, an exploded view of a nozzle cap and insert assembly 200 with a discharge nozzle 157 of FIG. 3 is shown. In FIG. 4, a top view of a nozzle cap and insert assembly 200 with a discharge nozzle 157 of FIG. 3 is shown. In FIG. 5, a cross-sectional side view of a nozzle cap and insert assembly 200 with a discharge nozzle 157 of FIG. 3 is shown. In FIG. 6, a cross-sectional side view of a nozzle cap and insert assembly 200 with a discharge nozzle 157 of FIG. 3 is shown.

The nozzle cap and insert assembly 200 can include the discharge nozzle 157, a nozzle cap 202, and a cap insert 204. The discharge nozzle 157 can additionally include a locking groove 302. In an implementation, the nozzle cap 202 additionally includes a nozzle attachment 206 and a locking protrusion 304.

The nozzle cap and insert assembly 200 may include a supply end (shown as ‘S’) and a discharge end (shown as ‘D’). The supply end of the nozzle cap and insert assembly 200 corresponds to the end of the discharge nozzle 157 that connects to the tank, manifold, other source of fire suppressant. The discharge end of the nozzle cap and insert assembly 200 depends on the end of the discharge nozzle 157 that includes an opening, aperture, or other structure to distribute or discharge the fire suppressant to an area. In an implementation, the supply end and the discharge end are positioned at opposite ends of the discharge nozzle 157.

The discharge nozzle 157 may include an elongated body (e.g., cylinder, rectangular prism, etc.) with a longitudinal length, at least one longitudinal face (i.e., a side or sides), and one or more transverse faces (i.e., a top or a bottom). As depicted in FIG. 3-6, the transverse face at the discharge end is the top of the discharge nozzle 157 and the transverse face at the supply end is the bottom of the discharge nozzle 157. The discharge nozzle 157 may include an aperture 300 located on a transverse face or a longitudinal face at the discharge end. In implementations, the discharge nozzle 157 may include a plurality of apertures 300 located on a transverse face, a longitudinal face, or combination thereof. As depicted in FIG. 3-6, the discharge nozzle 157 includes a cylindrical body with the aperture 300 located on the top of the nozzle. In implementations, the discharge nozzle 157 is made of a heat-resistive metal (e.g., brass, stainless steel, etc.).

The nozzle cap 202 may be structured as a cover, shield, case, lid, or other mechanical structures that encloses an end of the discharge nozzle 157. The nozzle cap 202 may include a top and sides that form a cavity. The cavity is structured in shape and dimension to enclose an end of the discharge nozzle 157. The top may be minimally sized to the shape and dimension of the top of the discharge nozzle 157. The sides may extend along a longitudinal length of the sides of the discharge nozzle 157. The cavity may provide a “close” or “snug” fit on the discharge nozzle 157, leaving minimal space in between the discharge nozzle 157 and the internal walls of the cavity. As depicted in FIG. 3-6, the top of the nozzle cap 202 is circular and the sidewalls of the nozzle cap 202 are rounded to enclose the cylindrical nozzle 157. In some implementations, the nozzle cap 202 is made of a polymer material.

In an implementation, a nozzle attachment 206 is coupled to the nozzle cap 202. The nozzle attachment 206 is structured as an extension protruding from the nozzle cap 202 and extending a length such that the nozzle attachment 206 may attach, couple, or adhere to the discharge nozzle 157, manifold, tank, or other structure on the supply end of the discharge nozzle 157. In an implementation, the nozzle attachment 206 includes a ring that slips over the discharge nozzle 157 or other structure on the supply end of the discharge nozzle 157.

The cap insert 204 may include a plate (e.g., disc, slab, etc.). In an implementation, the cap insert 204 additionally includes sidewalls perpendicularly connected to the edges or perimeter of the plate. The cap insert 204 may be constructed in shape and dimension to substantially or completely cover the top of the discharge nozzle 157. As depicted in FIGS. 3-6, the cap insert 204 is round to substantially or completely cover the top of the cylindrical discharge nozzle 157. In an implementation, the cap insert 204 is made of a material that maintains rigidity at high temperatures. In an implementation, the cap insert 204 is made of the same material as the discharge nozzle 157 (i.e., metal).

In assembling the nozzle cap and insert assembly 200, the cap insert 204 is positioned in between the discharge nozzle 157 and the inner cavity wall of the nozzle cap 202. As depicted in FIGS. 3-6, the cap insert 204 is positioned in between the top of the nozzle 157 and the inner wall of the top of the nozzle cap cavity. The cavity of the nozzle cap 202 may have a depth to enclose the cap insert 204 and a side of the discharge nozzle 157. In implementations, the discharge nozzle 157 and the nozzle cap 202 may include a locking mechanism that provides a stronger hold or fit of the nozzle cap 202 over the discharge nozzle 157. The locking mechanism may include a locking groove 302 along the sides of the discharge nozzle 157 and perpendicular to the longitudinal length of the discharge nozzle 157 and a locking protrusion 304 along a perimeter or inner wall of the nozzle cap 202 cavity. When assembled, the locking protrusion 304 of the nozzle cap 202 inserts into the locking groove of the discharge nozzle 157. As depicted in FIGS. 5-6, the locking groove 302 is along the circumference of the cylindrical discharge nozzle 157.

In some implementations, the discharge nozzle 157, the nozzle cap 202, and the cap insert 204 are manufactured independently from another. To couple the cap insert 204 to the nozzle cap 202, a force may be applied to the cap insert 204 to position the cap insert 204 into the cavity of the nozzle cap 202. In other implementations, the nozzle cap 202 is injected or molded around the cap insert 204 (e.g., overmolding).

### Cap Insert

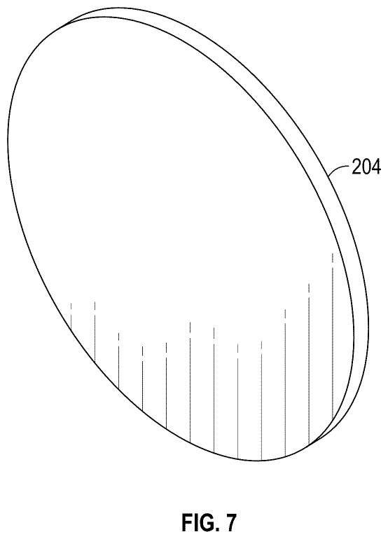

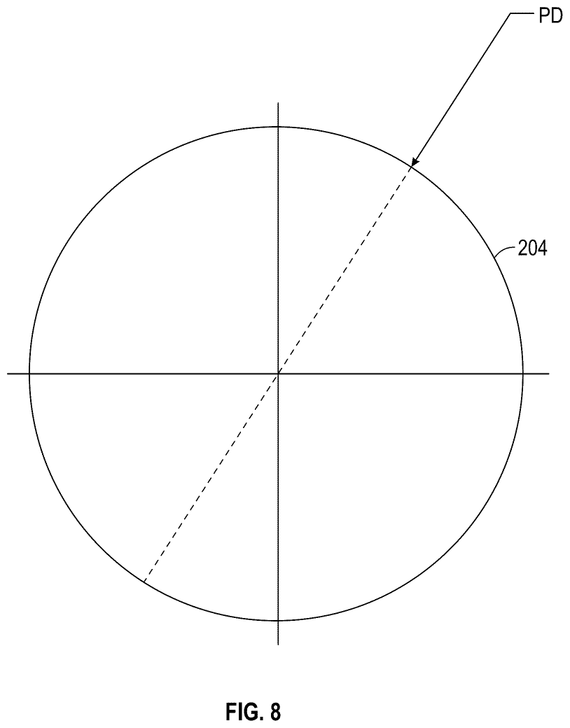

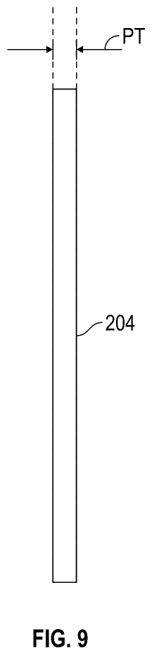

Referring to FIGS. 3-9, a cap insert 204 of FIG. 3 is shown. FIG. 7 a perspective view of a cap insert of FIG. 3 is shown. FIG. 8 a top view of a cap insert of FIG. 3. FIG. 9 a side view of a cap insert of FIG. 3 is shown.

The cap insert 204 may include a plate that has a first dimension (e.g., thickness, PT, etc.) and a second dimension (e.g., diameter, PD, etc.). The thickness of the plate is sized to permit the cap insert 204 to fit inside the cavity of the nozzle cap 202 without impeding the nozzle cap 202 from displacement off the discharge nozzle 157 when a fire suppressant is distributed or discharged from the discharge nozzle 157. In an implementation, the plate thickness is between 0.02-0.05 inch. The plate diameter can substantially or completely cover the top of the discharge nozzle 157 (e.g., shaped and sized the same or greater dimensions than the top of the discharge nozzle 157). In an implementation, the plate diameter is 0.85-1.00 inch. As depicted in FIGS. 3-9, the plate of the cap insert 204 is round to cover a cylindrical discharge nozzle 157.

The cap insert may substantially or completely cover the aperture 300 of the discharge nozzle 157. As depicted in FIGS. 3-9, the cap insert includes a round plate to cover an aperture 300 on the top of the discharge nozzle 157. In some implementations, the cap insert 204 include a perforation. The perforation is located on the cap insert 204 such that when the cap insert 204 centered to the top of the discharge nozzle 157, the perforation does not overlap with the aperture 300. Additionally, the cap insert may include a series of perforations. The perforations are minimally sized relative to the total surface area of the cap insert 204. In an implementation, the cap insert 204 is made of brass. The perforations may span the thickness of the cap insert 204.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various implementations, are intended to indicate that such implementations are possible examples, representations, or illustrations of possible implementations (and such terms are not intended to connote that such implementations are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other implementations, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various implementations is illustrative only. Additionally, any element disclosed in one implementation may be incorporated or utilized with any other implementation disclosed herein. Although only one example of an element from one implementation that can be incorporated or utilized in another implementation has been described above, it should be appreciated that other elements of the various implementations may be incorporated or utilized with any of the other implementations disclosed herein.

What is claimed is:

1. A nozzle cap and insert assembly comprising:
a discharge nozzle with a first aperture
an insert including a plate structured to substantially or completely cover a top of the discharge nozzle; and
a nozzle cap with a cavity depth equal to a thickness of the plate and a length along the discharge nozzle.

2. The nozzle cap and insert assembly of claim 1, wherein the discharge nozzle is cylindrical.

3. The nozzle cap and insert assembly of claim 1, wherein the first aperture is located on the top of the discharge nozzle, and the plate of the insert is structured to substantially or completely cover the first aperture.

4. The nozzle cap and insert assembly of claim 1, wherein the first aperture is located on a longitudinal face of the discharge nozzle; and the insert further includes a side wall perpendicularly connected to an edge of the plate and substantially or completely covering the first aperture.

5. The nozzle cap and insert assembly of claim 3, wherein the plate of the insert further includes a perforation located such that the perforation does not overlap with the first aperture when the plate is centered to the top of the discharge nozzle.

6. The nozzle cap and insert assembly of claim 1, wherein the discharge nozzle further includes a second aperture.

7. The nozzle cap and insert assembly of claim 1, wherein the nozzle cap is made of a polymer material.

8. The nozzle cap and insert assembly of claim 1, wherein the insert is made of a heat-resistive rigid material.

9. A nozzle cap and insert assembly comprising:
a discharge nozzle including a first aperture on a top of a cylindrical discharge nozzle; and
an insert including a plate structured to substantially or completely cover the top and the first aperture of the discharge nozzle; and
a nozzle cap with a cavity depth equal to a thickness of the plate and a length along the discharge nozzle.

10. The nozzle cap and insert assembly of claim 9, wherein the plate of the insert further includes a perforation located such that the perforation does not overlap with the first aperture when the plate is centered with the top of the discharge nozzle.

11. The nozzle cap and insert assembly of claim 9, wherein the discharge nozzle further includes a second aperture.

12. The nozzle cap and insert assembly of claim 9, wherein the nozzle cap is made of a polymer material and the insert is made of a heat-resistive rigid material.

13. The nozzle cap and insert assembly of claim 9, wherein the discharge nozzle includes a circumferential groove on a side of the discharge nozzle and the nozzle cap includes a protrusion along an edge of the nozzle cap, wherein the protrusion is structured to couple with the circumferential groove.

14. The nozzle cap and insert assembly of claim 9, further including a nozzle attachment comprising a first end with a ring structured to slip around a circumference of the discharge nozzle and a second end protruding from an external portion of the nozzle cap.

15. The nozzle cap and insert assembly of claim 9, wherein the insert further includes a side wall perpendicularly connected to an edge of the plate.

16. An insert comprising:
a circular plate with a thickness and made of a heat-resistive rigid material, and
a perforation spanning the thickness.

17. The insert of claim 16, further including a side wall perpendicularly connected to an edge of the circular plate.

18. The insert of claim 16, wherein a diameter of the circular plate is equal or substantially similar to a diameter of a discharge nozzle with an aperture.

19. The insert of claim 18, wherein the perforation is located such that the perforation does not overlap with the aperture when the circular plate is centered to a top of the discharge nozzle.

20. The insert of claim of 18, wherein the insert is coupled with a discharge nozzle made of a heat-resistive rigid material.
